(19) United States
(12) Patent Application Publication
(10) Pub. No.: US 2017/0280201 A1
(43) Pub. Date: Sep. 28, 2017

(54) METHOD AND ELECTRONIC DEVICE FOR UPDATING PROGRAM GUIDE

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Long LI, Beijing (CN)

(21) Appl. No.: 15/245,574

(22) Filed: Aug. 24, 2016

Related U.S. Application Data
(63) Continuation of application No. PCT/CN2016/089330, filed on Jul. 8, 2016.

(30) Foreign Application Priority Data
Mar. 22, 2016 (CN) 201610166656.X

(51) Int. Cl. H04N 21/482; G06F 17/30; H04N 21/278; H04N 21/434; H04N 21/431

(52) U.S. Cl. CPC H04N 21/4821; H04N 21/4345; H04N 21/4828; H04N 21/4314; H04N 21/278; G06F 17/30038

(57) ABSTRACT

A method for program guide update includes: at an electronic device, acquiring program guide update data; comparing whether the program guide update data is the same as local program guide data; if not, comparing whether a quantity of program items contained in the program guide update data is the same as a quantity of program items contained in the local program guide data; recording primary item information and focus item information in a visual range of the program guide if the quantity of program items contained in the program guide update data is different from the quantity of program items contained in the local program guide data; updating the program guide according to the program guide update data; setting a visual range of an updated program guide according to the primary item information; and setting a focus item of the updated program guide according to the focus item information.

### CROSS REFERENCE TO RELATED APPLICATIONS

The present disclosure is a continuation application of PCT International patent application No. PCT/CN2016/089330, filed on Jul. 8, 2016, which claims priority to Chinese Patent Application No. 201610166656.X, filed with the Chinese Patent Office on Mar. 22, 2016, both of which are herein incorporated by reference in their entireties.

### TECHNICAL FIELD

The present disclosure relates to the field of multimedia information technologies, and in particularly, to a method and an electronic device for program guide update.

### BACKGROUND

A program guide of a video app has very strong time validity. When a new program goes online, an old program goes offline, or information of some programs changes, a program guide needs to be updated. A program guide is usually implemented by using a list control such as ListView and RecyclerView. Each of the controls connects a UI (user interface) to data by using an adapter. When new program data is acquired from a server, a data source of the adapter needs to be updated; a refresh operation of the adapter is called; the adapter notifies, according to the data source (which is updated to the newest program data at this time), the UI of the program guide of redrawing the UI; and the UI of the program guide is updated. The foregoing process is a basic process of refreshing a program guide in the prior art.

It can be seen from the earlier introduction that the UI can only be refreshed when the refresh method of the adapter is called and then the adapter notifies the UI of the program guide of redrawing the UI. The redrawing of the UI of a list control means that all the old items are cancelled and visible items from a first item to a last item are drawn one by one according to a new data source.

### SUMMARY

A method for program guide update is provided in an embodiment of the present disclosure. The method includes: at an electronic device, acquiring program guide update data; comparing whether the program guide update data is the same as local program guide data; giving up updating a program guide if the program guide update data is the same as the local program guide data; comparing whether a quantity of program items contained in the program guide update data is the same as a quantity of program items contained in the local program guide data if the program guide update data is not the same as the local program guide data; comparing the program guide update data with the local program guide data to obtain a different program item to be used as a program item to be updated if the quantity of program items contained in the program guide update data is the same as the quantity of program items contained in the local program guide data; updating the program guide according to the program item to be updated; recording primary item information and focus item information in a visual range of the program guide if the quantity of program items contained in the program guide update data is different from the quantity of program items contained in the local program guide data; updating the program guide according to the program guide update data; setting a visual range of an updated program guide according to the primary item information; and setting a focus item of the updated program guide according to the focus item information.

An electronic device is provided in another embodiment of the present disclosure. The electronic device includes at least one processor and a memory communicably connected with the at least one processor for storing instructions executable by the at least one processor, wherein execution of the instructions by the at least one processor causes the at least one processor to:

acquire program guide update data;

compare whether the program guide update data is the same as local program guide data;

give up updating a program guide if the program guide update data is the same as the local program guide data;

compare whether a quantity of program items contained in the program guide update data is the same as a quantity of program items contained in the local program guide data if the program guide update data is not the same as the local program guide data;

compare the program guide update data with the local program guide data to obtain a different program item to be used as a program item to be updated if the quantity of program items contained in the program guide update data is the same as the quantity of program items contained in the local program guide data;

update the program guide according to the program item to be updated;

record primary item information and focus item information in a visual range of the program guide if the quantity of program items contained in the program guide update data is different from the quantity of program items contained in the local program guide data;

update the program guide according to the program guide update data;

set a visual range of an updated program guide according to the primary item information; and

set a focus item of the updated program guide according to the focus item information.

A non-transitory computer-readable storage medium is provided in still another embodiment of the present disclosure. The non-transitory computer-readable storage medium stores executable instructions, wherein when executed by an electronic device, causes the electronic device to:

acquire program guide update data;

compare whether the program guide update data is the same as local program guide data;

give up updating a program guide if the program guide update data is the same as the local program guide data;

compare whether a quantity of program items contained in the program guide update data is the same as a quantity of program items contained in the local program guide data if the program guide update data is not the same as the local program guide data;

compare the program guide update data with the local program guide data to obtain a different program item to be used as a program item to be updated if the quantity of program items contained in the program guide update data is the same as the quantity of program items contained in the local program guide data;

update the program guide according to the program item to be updated;

record primary item information and focus item information in a visual range of the program guide if the quantity of program items contained in the program guide update data is different from the quantity of program items contained in the local program guide data;

update the program guide according to the program guide update data;

set a visual range of an updated program guide according to the primary item information; and

set a focus item of the updated program guide according to the focus item information.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for program guide update according to an embodiment of the present disclosure;

FIG. 2 is a flowchart of a method for program guide update according to another embodiment of the present disclosure;

FIG. 3 is a schematic structural diagram of an apparatus for program guide update according to an embodiment of the present disclosure; and

FIG. 4 is a schematic structural diagram of a video playing terminal according to an embodiment of the present disclosure.

### DETAILED DESCRIPTION

To make the objectives, technical solutions, and advantages of the present disclosure clearer, the following further describes the present disclosure in detail with reference to the embodiments and the accompanying drawings.

It should be noted that, the expressions of “first” and “second” in the embodiments of the present disclosure are intended to distinguish between two different entities or two different parameters with identical names. Hence, “first” and “second” are merely provided for the convenience of expression, but should not be construed as a limitation to the embodiments of the present disclosure, which is not described in the subsequent embodiments again.

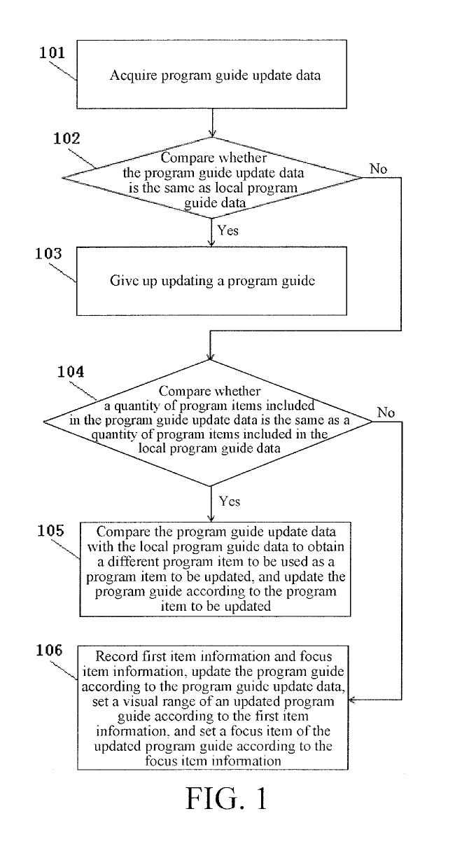

FIG. 1 is a flowchart of a method for program guide update according to an embodiment of the present disclosure.

The method for program guide update, including the following steps:

In Step 101: Acquire program guide update data.

In this step, newest program guide update data is acquired from a server at a network end. The program guide update data is generated by the server, and is regularly pushed to each terminal. Alternatively, when newest program guide update data is generated, the newest program guide update data is immediately pushed to each terminal.

In Step 102: Compare whether the program guide update data is the same as local program guide data, and if yes, perform step 103; and if not, perform step 104.

In this step, whether the program guide update data is the same as the locally stored program guide data is determined in a data comparison manner.

In Step 103: Give up updating a program guide.

When it is determined that the program guide update data is the same as the locally stored program guide data, in order to avoid an excess update process, the program guide update data acquired this time is ignored, and the program guide is not updated.

In Step 104: Compare whether a quantity of program items included in the program guide update data is the same as a quantity of program items included in the local program guide data; if the quantity of program items included in the program guide update data is the same as the quantity of program items included in the local program guide data, perform step 105; and if the quantity of program items included in the program guide update data is different from the quantity of program items included in the local program guide data, perform step 106.

When it is determined that the program guide update data is different from the locally stored program guide data, the program guide update data and the local program guide data are further read to obtain the quantity of items included in each of them, and whether the quantity of program items included in the program guide update data is the same as the quantity of program items included in the local program guide data is compared.

In Step 105: Compare the program guide update data with the local program guide data to obtain a different program item to be used as a program item to be updated, and update the program guide according to the program item to be updated.

When it is determined that the quantity of program items included in the program guide update data is the same as the quantity of program items included in the local program guide data, program items at corresponding positions of the program guide update data and the local program guide data are compared pair by pair to determine whether a pair of program items are the same, and if yes, the state indicates that the program item does not change in this update, and no processing is performed; and if not, the state indicates that the program item changes in this update, the program item is used as a program item to be updated, and a position sequence number of the program item in the program guide is acquired.

After all the program items to be updated are determined, the program guide is updated according to the program items to be updated, items of corresponding position sequence numbers in the program guide are found according to the position sequence numbers of the program items to be updated in the program guide, and the program items are redrawn according to data of the corresponding items in the program guide update data.

In Step 106: Record primary item information and focus item information in a visual range of the program guide, update the program guide according to the program guide update data, set a visual range of an updated program guide according to the primary item information, and set a focus item of the updated program guide according to the focus item information.

When it is determined that the quantity of program items included in the program guide update data is different from the quantity of program items included in the local program guide data, the quantity of items in the program guide changes. At this time, a position sequence number and content data of a focus item with a focus (that is, a program item that is selected by a user and is displayed in a special display state, such as highlighted) in an original program guide, and a position sequence number of a first item in a visual range of the original program guide are recorded. Then, the program guide is integrally redrawn and updated by using a method in the prior art. Finally, a visual range of the updated program guide is adjusted, that is, the visual range of the updated program guide is adjusted by sliding, so as to adjust the visual range to the recorded position of the first item in the original program guide or to a position closest thereto, so that a part of the updated program guide seen by a user is the part of program items in the original program guide that were seen by the user. Then, the focus item in the original program guide is also set as a focus item in the updated program guide.

It can be seen from the foregoing embodiments that, to resolve a problem of unnecessary program guide 111 refresh and a problem of a sudden change of the UI caused thereby, the method for program guide update of the present disclosure filters several steps in a program guide update process in the prior art, skips unnecessary steps, and reduces a side effect on a UI even the unnecessary steps are performed. If new data is consistent with old data, a UI is not refreshed. If new data is inconsistent with old data but a new quantity of items is consistent with an old quantity of items, the state indicates that there is a great chance that a same item is correspondingly at a same position. At this time, a position of an item to be updated is determined, and then the item is updated individually. If content and a quantity of items of new data are inconsistent with content and a quantity of items of old data, the state is complex, and a whole list is updated by using an old approach. To maintain the consistency of a first item position and a focus item position of a list, a first item position of an original list needs to be recorded, and content and a position of an item with a focus are obtained. After refresh is completed, the list is scrolled to the top item position (or a position closest thereto), so as to enable the original focus item to obtain a focus again. By means of the foregoing method, redundant refresh steps in a program guide update process are effectively eliminated, entire performance of a UI is free from being affected, and the program guide update process is visually consistent and smooth.

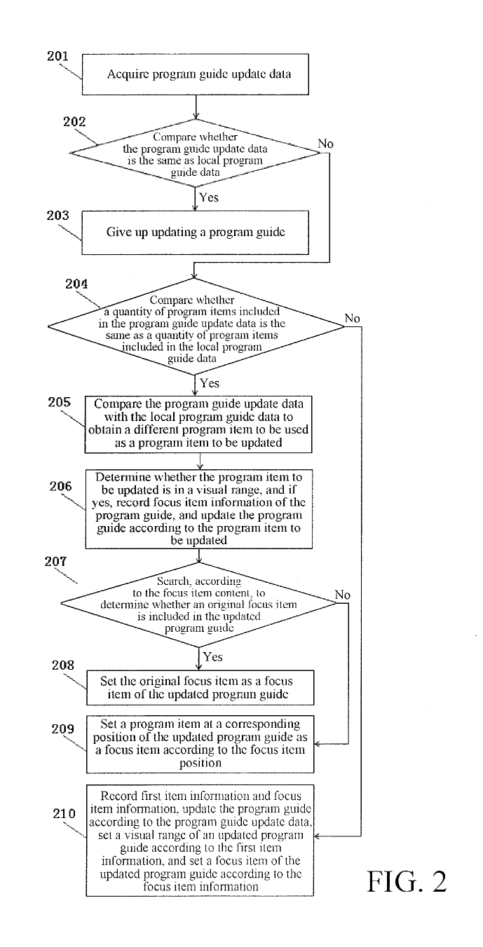

FIG. 2 is a flowchart of a method for program guide update according to another embodiment of the present disclosure.

In some exemplary embodiments, the method for program guide update includes the following steps:

In Step 201: Acquire program guide update data.

In Step 202: Compare whether the program guide update data is the same as local program guide data, and if yes, perform step 203; and if not, perform step 204.

In Step 203: Give up updating a program guide.

In Step 204: Compare whether a quantity of program items included in the program guide update data is the same as a quantity of program items included in the local program guide data; if the quantity of program items included in the program guide update data is the same as the quantity of program items included in the local program guide data, perform step 205; and if the quantity of program items included in the program guide update data is different from the quantity of program items included in the local program guide data, perform step 210.

In Step 205: Compare the program guide update data with the local program guide data to obtain a different program item to be used as a program item to be updated.

In this embodiment, a method process used in comparing the program guide update data with the local program guide data to obtain the different program item includes:

First, extract data segments for display in two program items at a same position of the program guide update data and the local program guide data. Second, output the data segments for display as character strings, and calculate MD5 values of the character strings. Third, compare whether the two MD5 values are the same, and if yes, determine that the two program items are the same; and if not, determine that the two program items are different.

The following is an example of a method for determining that the two program items are different.

Two pieces of data in the program guide update data and the local program guide data are:

{

channelId : 4;
channelName : “Sport”;
url:“http://www.baidu.com”;

}
and
{

channelId : 5;
channelName : “Sport”;
url:“http://www.baidu.com”;

}

(1) Extract parts in the data that affect display:

In the data, only values of two fields, the channelId (the channel ID) and the channelName (channel name) need to be displayed on a UI. The url is only used in internal logic of a program. During comparison, only the channelIds and the channelNames are taken into consideration.

(2) Print the parts in the data that affect display into character strings, and results are:

“channelId=4, channelName=Sport” and “channelId=5, channelName=Sport”

Printing sequences of the fields are specified in a code, and the sequences of the fields in the printed character strings are based on the specified sequences. Therefore, the sequences of the fields in the character strings are the same, and the sequences do not affect a comparison result. Moreover, a printing format is also specified in the code, and therefore, delimiters such as spaces and commas in the character strings are also the same and do not affect the comparison result.

(3) Calculate MD5 values of the character strings, and results are:

6e62bcbf804381fe8499a3cc72bb3e37 and ccb7fdd69fffee1ab73b2b827f197cc7.

An MD5 value may be of 16 bits or 32 bits, and 32 bits is selected herein. That is, an MD5 output result of any character string is a character string with a length of 32 bits. Only when character strings are completely the same, MD5 output results thereof are the same.

(4) Compare the two MD5 values, and if the two MD5 values are different, it indicates that the two pieces of data are different.

After the program guide update data and the local program guide data are traversed by using the method of this step, all the program items to be updated are obtained.

In Step 206: Determine whether the program item to be updated is in a visual range, and if yes, record focus item information of the program guide, and update the program guide according to the program item to be updated.

In this step, whether the program item to be updated is in the visual range of the updated program guide is predetermined; then it is described that a program item in the visual range of the program guide changes, and focus item information of a focus item in an original program guide is recorded, including a focus item position and focus item content; and then further processing is performed in a subsequent step.

When a determining result is that the program item to be updated is not in the visual range, update is not performed, because when the program guide slides, a list control draws, according to the newest program guide update data, a program item newly entering the visual range.

In Step 207: Search, according to the focus item content, to determine whether an original focus item is included in the updated program guide, and if yes, perform step 208; and if not, perform step 209.

In Step 208: Set the original focus item as a focus item of the updated program guide.

If the original focus item is still included in the updated program guide, the original focus item is found in the updated program guide according to the focus item content of the original focus item, and the original focus item is correspondingly set as the focus item again.

In Step 209: Set a program item at a corresponding position of the updated program guide as a focus item according to the focus item position.

If the original focus item is not included in the updated program guide, a program item at a position, the same as the position of the original focus item, in the updated program guide is set as a focus item according to the focus item position of the original focus item. For example, a focus item in an original program guide is the fourth item, and content of the fourth item in an updated program guide is different from that of the fourth item of the original program guide, the fourth item in the updated program guide is set as a focus item.

In Step 210: Record primary item information and focus item information in a visual range of the program guide, update the program guide according to the program guide update data, set a visual range of an updated program guide according to the primary item information, and set a focus item of the updated program guide according to the focus item information.

Preferably, a process of setting a focus item of the updated program guide according to the focus item information in this step also uses the method process as described in step 206 to step 209.

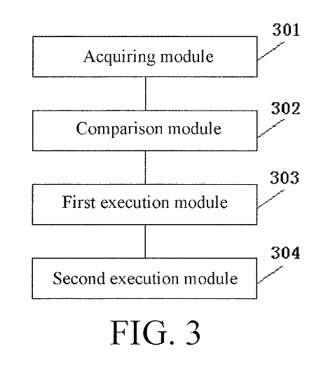

FIG. 3 is a schematic structural diagram of an apparatus for program guide update according to an embodiment of the present disclosure.

The apparatus for program guide update includes: an acquiring module 301, a comparison module 302, a first execution module 303, and a second execution module 304.

The acquiring module 301 is configured to acquire program guide update data.

The comparison module 302 is configured to compare whether the program guide update data is the same as local program guide data, and if yes, give up update; and if not, further compare whether a quantity of program items included in the program guide update data is the same as a quantity of program items included in the local program guide data.

The first execution module 303 is configured to compare, if the quantity of program items included in the program guide update data is the same as the quantity of program items included in the local program guide data, the program guide update data with the local program guide data to obtain a different program item to be used as a program item to be updated, and update the program guide according to the program item to be updated.

The second execution module 304 is configured to record, if the quantity of program items included in the program guide update data is different from the quantity of program items included in the local program guide data, primary item information and focus item information in a visual range of the program guide, update the program guide according to the program guide update data, set a visual range of an updated program guide according to the primary item information, and set a focus item of the updated program guide according to the focus item information.

In some exemplary embodiments, the first execution module 303 is further configured to: extract data segments for display in two program items at a same position of the program guide update data and the local program guide data; output the data segments for display as character strings, and calculate MD5 values of the character strings; and compare whether the two MD5 values are the same, if yes, determine that the two program items are the same, and if not, determine that the two program items are different. Each MD5 value is of 32 bits.

In some exemplary embodiments, the first execution module 303 is further configured to: determine whether the program item to be updated is in the visual range; and if yes, record the focus item information in the program guide, update the program guide according to the program item to be updated, and set a focus item in the updated program guide according to the focus item information.

In some exemplary embodiments, the focus item information includes a focus item position and focus item content; and the first execution module 303 is further configured to: search, according to the focus item content, to determine whether an original focus item is included in the updated program guide, and if yes, set the original focus item as the focus item of the updated program guide; and if not, set a program item at a corresponding position of the updated program guide as the focus item according to the focus item position.

The apparatus for program guide update of the foregoing embodiment is configured to implement the corresponding program guide update method of the earlier embodiments, and has the beneficial effects of the corresponding method, and details are not described herein again.

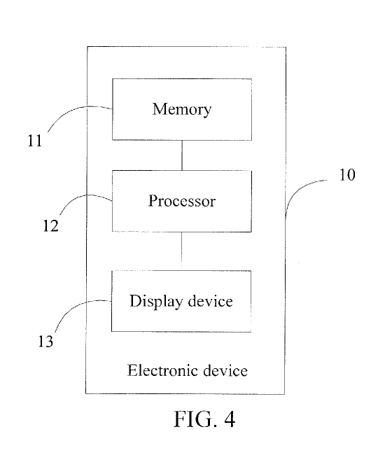

FIG. 4 is a schematic structural diagram of a video playing terminal 10 provided in an embodiment of the present disclosure. As shown in FIG. 5, the video playing terminal 10 includes a memory 11, a processor 12, and a display device 13.

The memory 11 is configured to store instructions.

The processor 12 is caused to execute the instructions stored in the memory 11, so as to acquire program guide update data, compare whether the program guide update data is the same as local program guide data, and if yes, give up updating a program guide; and if not, further compare whether a quantity of program items included in the program guide update data is the same as a quantity of program items included in the local program guide data; compare, if the quantity of program items included in the program guide update data is the same as the quantity of program items included in the local program guide data, the program guide update data with the local program guide data to obtain a different program item to be used as a program item to be updated, and update the program guide according to the program item to be updated; record, if the quantity of program items included in the program guide update data is different from the quantity of program items included in the local program guide data, primary item information and focus item information in a visual range of the program guide, update the program guide according to the program guide update data, set a visual range of an updated program guide according to the primary item information, and set a focus item of the updated program guide according to the focus item information.

The display device 13 is configured to display graphic user interface.

The memory 11 of the video playing terminal 10 may be a non-transitory computer readable storage medium for storing computer executable instructions. For example, when being executed by one or more processors, enable the processor to execute steps of the method in the embodiments described above, e.g., the steps 101 to 106 described in FIG. 1, or the steps 201 to 210 described in FIG. 2, or achieve the function of units 301-304 described in FIG. 3. The computer executable instructions may also be stored and/or transmitted in any non-transitory computer readable storage medium for use in an instruction execution system, apparatus or device or for use in combination with an instruction execution system, apparatus or device. The instruction execution system, apparatus or device is, for example, a computer-based system, a system including a processor, or some other system that can obtain instructions from the instruction execution system, apparatus or device and execute the instructions. For purpose of this document, the “non-transitory computer readable storage medium” may be any tangible medium that contains or stores computer executable instructions which may be used by or in combination with the instruction execution system, apparatus or device. The non-transitory computer readable storage medium may include but is not limited to magnetic, optical and/or semiconductor storage devices. Examples of these storage devices include magnetic disks, optical disks based on CD, DVD or Blu-ray technologies, and persistent solid-state storages (e.g., flash memories, solid-state drives and etc).

The processor 12 may be a central processing unit (CPU). The processor 12 may also be some other general-purpose processor, digital signal processor (DSP), application specific integrated circuit (ASIC), field programmable gate array (FPGA) or some other programmable logic element, discrete gate or transistor logic element, discrete hardware component and etc. The general-purpose processor may be a microprocessor or may be any common processor.

The processor 12 and the memory 11 is, directly or indirectly, in communication with each other by means of any appropriate means including, but not limiting to power supply buses, control buses, state signal buses and so on, so as to achieve data transmission.

By performing the method for program guide update described in FIGS. 1 and 2, the video playing terminal 10 of the embodiments of the present disclosure can eliminate redundant program guide refresh and avoid affecting the entire performance of the UI, so that visual consistency is ensured. When partial refresh is performed, a list does not flicker.

As shall be understood by those skilled in the art, various functional units/modules and various steps may be implemented by electrical hardware, computer software, or the combination of both. In order to clearly illustrate the interchangeability of electrical hardware and computer software, the functional units/modules and steps of the above embodiments are described in a general way. Performing the functional units/modules and steps of the above embodiments by means of electrical hardware, computer software, or the combination of both, depends on the specific applications and design constrain conditions of the technical solutions. Those skilled in the art may apply different solutions for each specific application to achieve the functional units/modules and steps of the above embodiments, however, these different solutions should be deemed to be within the scope of the present disclosure. The computer software may be stored in a computed readable storage medium, and can perform the steps of the method in the above described embodiments when being executed. Wherein, the storage medium may be a magnetic disk, an optical disc, a read-only memory, a random memory or the like.

A person of ordinary skill in the art should understand: the above discussion on any embodiments is merely exemplary, and is not intended to imply that the scope of the present disclosure (including the claims) is limited to the embodiments; and in light of the inventive thought of the present disclosure, technical features of the foregoing embodiment or different embodiments may be combined, steps may be implemented in any sequence, and there are many other variations to the aforementioned different aspects of the present disclosure, which are not provided in the details for the purpose of conciseness and clearness. Therefore, any omission, modification, equivalent replacement, and improvement made within the spirit and principle of the present disclosure shall fall within the protection scope of the present disclosure.

What is claimed is:

1. A method for program guide update, comprising:
at an electronic device;
acquiring program guide update data;
comparing whether the program guide update data is the same as local program guide data;
giving up updating a program guide if the program guide update data is the same as the local program guide data;
comparing whether a quantity of program items contained in the program guide update data is the same as a quantity of program items contained in the local program guide data if the program guide update data is not the same as the local program guide data;
comparing the program guide update data with the local program guide data to obtain a different program item to be used as a program item to be updated if the quantity of program items contained in the program guide update data is the same as the quantity of program items contained in the local program guide data;
updating the program guide according to the program item to be updated;
recording primary item information and focus item information in a visual range of the program guide if the quantity of program items contained in the program guide update data is different from the quantity of program items contained in the local program guide data;
updating the program guide according to the program guide update data;
setting a visual range of an updated program guide according to the primary item information; and
setting a focus item of the updated program guide according to the focus item information.

2. The method according to claim 1, wherein comparing the program guide update data with the local program guide data to obtain a different program item to be used as a program item to be updated comprises:
extracting data segments for display in two program items at a same position of the program guide update data and the local program guide data;
outputting the data segments for display as character strings;
calculating MD5 values of the character strings; and
comparing whether the two MD5 values are the same; and
determining that the two program items are the same if the two MD5 values are the same.

3. The method according to claim 1, wherein comparing the program guide update data with the local program guide data to obtain a different program item to be used as a program item to be updated if the quantity of program items contained in the program guide update data is the same as the quantity of program items contained in the local program guide data, and updating the program guide according to the program item to be updated comprises:
comparing the program guide update data with the local program guide data to obtain the different program item to be used as the program item to be updated;
acquiring a position sequence number of the program item to be updated in the program guide;
finding an item of a corresponding position sequence number in the program guide according to the position sequence number of the program item to be updated in the program guide: and
redrawing the program item to be updated according to data of the corresponding item in the program guide update data.

4. The method according to claim 1, wherein when it is determined that the quantity of program items contained in the program guide update data is the same as the quantity of program items contained in the local program guide data, the method further comprises:
determining whether the program item to be updated is in the visual range;
recording the focus item information in the program guide if the program item to be updated is in the visual range;
updating the program guide according to the program item to be updated; and
setting a focus item in the updated program guide according to the focus item information.

5. The method according to claim 1, wherein the focus item information comprises a focus item position and focus item content, and setting a focus item in the updated program guide according to the focus item information comprises:
searching, according to the focus item content, to determine whether an original focus item is contained in the updated program guide;
setting the original focus item as the focus item of the updated program guide if the original focus item is contained in the updated program guide; and
setting a program item at a corresponding position of the updated program guide as the focus item according to the focus item position if the original focus item is not contained in the updated program guide.

6. An electronic device, comprising:
at least one processor; and
a memory communicably connected with the at least one processor for storing instructions executable by the at least one processor, wherein execution of the instructions by the at least one processor causes the at least one processor to:
acquire program guide update data;
compare whether the program guide update data is the same as local program guide data;
give up updating a program guide if the program guide update data is the same as the local program guide data;
compare whether a quantity of program items contained in the program guide update data is the same as a quantity of program items contained in the local program guide data if the program guide update data is not the same as the local program guide data;
compare the program guide update data with the local program guide data to obtain a different program item to be used as a program item to be updated if the quantity of program items contained in the program guide update data is the same as the quantity of program items contained in the local program guide data;
update the program guide according to the program item to be updated;
record primary item information and focus item information in a visual range of the program guide if the quantity of program items contained in the program guide update data is different from the quantity of program items contained in the local program guide data;
update the program guide according to the program guide update data;
set a visual range of an updated program guide according to the primary item information; and
set a focus item of the updated program guide according to the focus item information.

7. The electronic device according to claim 6, wherein comparing the program guide update data with the local program guide data to obtain a different program item to be used as a program item to be updated comprises:
extracting data segments for display in two program items at a same position of the program guide update data and the local program guide data;
outputting the data segments for display as character strings;
calculating MD5 values of the character strings; and
comparing whether the two MD5 values are the same; and
determining that the two program items are the same if the two MD5 values are the same.

8. The electronic device according to claim 6, wherein comparing the program guide update data with the local program guide data to obtain a different program item to be used as a program item to be updated if the quantity of program items contained in the program guide update data is the same as the quantity of program items contained in the local program guide data, and update the program guide according to the program item to be updated comprises:
comparing the program guide update data with the local program guide data to obtain the different program item to be used as the program item to be updated;
acquiring a position sequence number of the program item to be updated in the program guide;
finding an item of a corresponding position sequence number in the program guide according to the position sequence number of the program item to be updated in the program guide: and
redrawing the program item to be updated according to data of the corresponding item in the program guide update data.

9. The electronic device according to claim 6, wherein when it is determined that the quantity of program items contained in the program guide update data is the same as the quantity of program items contained in the local program guide data, execution of the instructions by the at least one processor further causes the at least one processor to:
determine whether the program item to be updated is in the visual range;
record the focus item information in the program guide if the program item to be updated is in the visual range;
update the program guide according to the program item to be updated; and
set a focus item in the updated program guide according to the focus item information.

10. The electronic device according to claim 6, wherein the focus item information comprises a focus item position and focus item content, and setting a focus item in the updated program guide according to the focus item information comprises:
searching, according to the focus item content, to determine whether an original focus item is contained in the updated program guide;
setting the original focus item as the focus item of the updated program guide if the original focus item is contained in the updated program guide; and
setting a program item at a corresponding position of the updated program guide as the focus item according to the focus item position if the original focus item is not contained in the updated program guide.

11. A non-transitory computer-readable storage medium storing executable instructions, wherein when executed by an electronic device, causes the electronic device to:
acquire program guide update data;
compare whether the program guide update data is the same as local program guide data;
give up updating a program guide if the program guide update data is the same as the local program guide data;
compare whether a quantity of program items contained in the program guide update data is the same as a quantity of program items contained in the local program guide data if the program guide update data is not the same as the local program guide data;
compare the program guide update data with the local program guide data to obtain a different program item to be used as a program item to be updated if the quantity of program items contained in the program guide update data is the same as the quantity of program items contained in the local program guide data;
update the program guide according to the program item to be updated;
record primary item information and focus item information in a visual range of the program guide if the quantity of program items contained in the program guide update data is different from the quantity of program items contained in the local program guide data;
update the program guide according to the program guide update data;
set a visual range of an updated program guide according to the primary item information; and
set a focus item of the updated program guide according to the focus item information.

12. The non-transitory computer-readable storage medium according to claim 11, wherein comparing the program guide update data with the local program guide data to obtain a different program item to be used as a program item to be updated comprises:
extracting data segments for display in two program items at a same position of the program guide update data and the local program guide data;
outputting the data segments for display as character strings;
calculating MD5 values of the character strings; and
comparing whether the two MD5 values are the same; and
determining that the two program items are the same if the two MD5 values are the same.

13. The non-transitory computer-readable storage medium according to claim 11, wherein comparing the program guide update data with the local program guide data to obtain a different program item to be used as a program item to be updated if the quantity of program items contained in the program guide update data is the same as the quantity of program items contained in the local program guide data, and updating the program guide according to the program item to be updated comprises:
comparing the program guide update data with the local program guide data to obtain the different program item to be used as the program item to be updated;
acquiring a position sequence number of the program item to be updated in the program guide;
finding an item of a corresponding position sequence number in the program guide according to the position sequence number of the program item to be updated in the program guide: and
redrawing the program item to be updated according to data of the corresponding item in the program guide update data.

14. The non-transitory computer-readable storage medium according to claim 11, wherein when it is determined that the quantity of program items contained in the program guide update data is the same as the quantity of program items contained in the local program guide data, the executable instructions are executed by the electronic device, further causes the electronic device to:
determine whether the program item to be updated is in the visual range;
record the focus item information in the program guide if the program item to be updated is in the visual range;
update the program guide according to the program item to be updated; and
set a focus item in the updated program guide according to the focus item information.

15. The non-transitory computer-readable storage medium according to claim 11, wherein the focus item information comprises a focus item position and focus item content, and setting a focus item in the updated program guide according to the focus item information comprises:
searching, according to the focus item content, to determine whether an original focus item is contained in the updated program guide;
setting the original focus item as the focus item of the updated program guide if the original focus item is contained in the updated program guide; and
setting a program item at a corresponding position of the updated program guide as the focus item according to the focus item position if the original focus item is not contained in the updated program guide.
